(19) United States
(12) Patent Application Publication
(10) Pub. No.: US 2025/0054468 A1
(43) Pub. Date: Feb. 13, 2025

(54) Stringed Musical Instruments with Interchangeable Head Assemblies

(71) Applicants: Paul E. VOGT, Kings Mountain, NC (US); Baruch Levi LEEDS, Brooklyn, NY (US)

(72) Inventors: Paul E. VOGT, Kings Mountain, NC (US); Baruch Levi LEEDS, Brooklyn, NY (US)

(21) Appl. No.: 18/800,664

(22) Filed: Aug. 12, 2024

Related U.S. Application Data
(60) Provisional application No. 63/532,019, filed on Aug. 10, 2023.

(51) Int. Cl. G10D 1/08; G10D 3/095

(52) U.S. Cl. CPC G10D 1/08; G10D 3/095

(57) ABSTRACT

Methods and apparatus for a stringed musical instrument, the instrument comprising an instrument body, a neck extending from the instrument body, a head, and a coupler having a bulkhead portion that adapts the shape of a portion of the neck to the shape of a portion of the head. A bulkhead portion of the coupler is adapted to be affixed to the neck in a permanent or temporary manner. The head can be attached to the neck via the coupler in a releasable manner. In some embodiments, a positioning key extends from the coupler bulkhead portion and the head includes a cavity adapted to receive the positioning key.

### CROSS-REFERENCE TO RELATED APPLICATIONS

This application claims benefit of U.S. provisional patent application Ser. No. 63/532,019 filed Aug. 10, 2023, which is herein incorporated by reference in its entirety.

### FIELD

Embodiments of the present disclosure generally relate to stringed musical instruments, and more particularly, to stringed musical instruments with interchangeable head assemblies and methods of manufacture therefor.

### BACKGROUND

Stringed musical instruments are typically divided into two categories, either bowed instruments such as violins or plucked instruments such as lutes and guitars. Such instruments typically comprise a body, a neck assembly extending from the body, a head (sometimes referred to as a headstock) fastened to the other end of the neck assembly, and a set of strings that extend from a plurality of tuning keys located on the head to a string fastening means located on the body of the instrument. As a result, when the strings are strummed or plucked, the strings and body of the instrument resonate and produce sounds.

Traditionally, commercially available guitars and other stringed instruments are often sold as fully assembled instruments, where the neck and the body are bolted to one another while the neck and head are manufactured together so as to form an integral instrument, such that neither the neck nor the head are normally expected to be separable one from one another by the user of the instrument. Thus, traditionally neither the neck nor the head are individually replaceable.

More recently, stringed instruments are available in which components can be assembled and swapped out, not only to form instruments with differing musical properties but also musical instruments that provide a different look and feel experience for the user. However, even minor differences in the physical size or connective relationship of the parts of the instrument may require a luthier to modify the instrument to achieve a desired sound.

Furthermore, not only is the sound and playability important for stringed instruments having interchangeable head assemblies, but so are the strength and durability properties of the assembled instrument. Whatever device or manufacturing technique is used to allow components to be interchangeable, that device or manufacturing technique must also not weaken or reduce the durability of the assembled instrument. Moreover, the device or manufacturing technique utilized must not degrade the fitment of the components nor adversely affect the cost to manufacture.

Additionally, it is noted that in some musical instruments the strings impose large, tensile forces on the neck of the instrument, thereby tending to cause a warping and twisting of the neck. Further, as the instrument is tuned, the strings are further stretched, thereby imposing additional longitudinal stressing over the neck and body of the instrument. Thus, if this stress is not adequately controlled or resisted, warping and twisting of the neck will occur. As a result, the instrument will produce distorted notes when played. In fact, this warping and twisting can become so great that the strings can contact the neck in undesirable locations, thereby rendering the instrument unplayable.

Hence, the inventors believe that a need exists to provide high quality stringed instruments with more easily interchangeable head assemblies that create a desired sound, look and feel, fit, and finish.

### SUMMARY

The present disclosure provides embodiments of stringed musical instruments having a user-separable head-neck connection, improved methods of manufacture for such instruments, and embodiments of a coupler adapted for such user-separable head-neck connections. Embodiments of the disclosure may be incorporated into and used to make a completed stringed musical instrument or parts therefor, such parts being, for example, completed neck assemblies, or replaceable heads (or headstocks) adapted to be connected to neck assemblies in accordance with the present disclosure.

In some embodiments, a stringed musical instrument includes: an instrument body, a neck extending from the instrument body, a head, and a coupler having a bulkhead portion that adapts the shape of a portion of the neck to the shape of a portion of the head. A bulkhead portion of the coupler is adapted to be affixed to the neck in a permanent or temporary manner. The head can be attached to the neck via the coupler in a releasable manner. In some embodiments, a positioning key extends from the coupler bulkhead portion and the head includes a cavity adapted to receive the positioning key.

Example 1. A stringed musical instrument includes a body, a neck extending from the body, a head extending from the neck, and a coupler having a bulkhead portion that divides the coupler into first and second opposed sides, the first side having a shape adapted to match at least a portion of the shape of the neck and the second side having a shape adapted to match at least a portion of the shape of the head.

Example 2. The stringed instrument of example 1, wherein the first side of the coupler is adapted to abut and be permanently affixed to the neck and the second side of the coupler is adapted to abut and be releasably attached to the head.

Example 3. A neck assembly for a stringed musical instrument includes a neck and a coupler having a bulkhead portion that divides the coupler into first and second opposed sides, the first side being permanently attached to the neck and having a shape that matches at least a portion of the shape of the neck and wherein the second side of the coupler has a shape adapted to match at least a portion of the shape of a head to be releasably secured to the neck.

Example 4. The neck assembly for a stringed instrument of Example 3, further comprising a stiffener sandwiched between a fretboard on a topside of the neck and a grip on the bottom side of the neck, wherein the bulkhead portion of the coupler is shaped to abut against and match the shape of grip portion of the neck.

Example 5. The stringed instrument of Example 1, wherein the neck includes a coupler having a bulkhead portion and first and second positioning keys extending on opposed sides of the bulkhead portion, for releasably attaching the head to the neck.

Example 6. The stringed instrument of Example 5, wherein the first positioning key is affixed to the neck so that the bulkhead portion of the coupler facing the neck provides a first finishing surface to the neck and the second positioning key is affixed to the head so that the bulkhead portion of the coupler facing the head provides a second finishing surface to the head.

Example 7. The stringed instrument of Example 6, wherein one of the first or second positioning keys is affixed using releasable attaching means.

Example 8. The stringed instrument of Example 7, wherein the first positioning key is permanently affixed to the neck and the second positioning key is adapted to releasably fit into a cavity formed in a portion of the head so as to permit a releasable connection of the head to the neck when the second positioning key is positioned in the cavity of the head.

Example 9. The stringed instrument of Example 8, wherein the second positioning key has a width of at least 50% or more of the average width of the head at its connection with the coupler and a thickness of about 25% or more of the average thickness of the head at its connection with the coupler.

Example 10. The stringed instrument of Example 8, wherein the releasable attaching means comprise a first threaded means adapted to pass through a hole formed along a longitudinal axis of the head and thread into a hole in the second positioning key.

Example 11. The stringed instrument of Example 8, wherein the second positioning key has a width of at least 50% or more of the average width of the head at its connection with the coupler and a thickness of at least 25% or more of the average thickness of the head at its connection with the coupler.

Example 12. The stringed instrument of Example 11, where releasable attaching means comprise a first threaded means adapted to pass in a first direction through the second positioning key and a mortise portion of the head and a second threaded means adapted to pass in a second direction, substantially perpendicular to the first direction, through the head and into the bulkhead portion of the coupler facing the head.

Example 13. The stringed instrument of Example 12, wherein the second positioning key has at least one hole formed therein that aligns with at least one threaded hole in the head mortise, for releasably securing the head to the neck with the first threaded means, and the head has a hole formed therein that aligns a threaded hole in the bulkhead for releasably securing the head to the neck with the second threaded means.

Example 14. The stringed instrument of Example 8, wherein the first positioning key is permanently affixed to a metallic support in the neck.

Example 15. The stringed instrument of Example 5, the neck side of the bulkhead provides finish to a grip portion of the neck and a nut mounted on the second positioning key provides a finishing surface for a fingerboard portion of the neck.

Example 16. A stringed musical instrument, comprising: an instrument body; a neck extending from the instrument body; and a head; wherein the improvement comprises a coupler adapted to be positioned between the neck and the head, the coupler including a first positioning key extending on one side thereof for permanently connecting the coupler to the neck, and a second positioning key extending from an opposed side thereof; the head including a cavity adapted to receive the second positioning key; and the head and the neck being configured to attach to one another using the second positioning key and cavity to form one of a lap or mortise joint, thereby forming a releasable connection of the head to the neck.

Example 17. The stringed musical instrument of Example 16, wherein the second positioning key has a width of at least 50% or more of the average width of the head at its connection with the neck and a thickness of at least 25% or more of the average thickness of the head at its connection with the neck.

Example 18. The stringed musical instrument of Example 16, further including releasable attaching means, comprising: a first threaded means adapted to pass in a first direction through the positioning key and cavity of the lap or mortise joint and a second threaded means adapted to pass in a second direction, substantially perpendicular to the first direction, through the head and into the coupler.

Example 19. The stringed musical instrument of Example 17, further including releasable attaching means, comprising: a first threaded means adapted to pass in a first direction through the positioning key and cavity of the lap or mortise joint and a second threaded means adapted to pass in a second direction, substantially perpendicular to the first direction, through the head and into the coupler.

Example 20. A method for manufacturing a stringed musical instrument, comprising: optionally manufacturing an instrument body; optionally manufacturing an instrument head; optionally manufacturing a neck assembly; optionally manufacturing a coupler, the coupler having first and second positioning key portions extending therefrom in opposed directions; and connecting the coupler to the neck assembly by securing the first positioning key of the coupler to the neck assembly and connecting the coupler to the head by securing the second positioning key of the coupler to the head, wherein one of the first and second positioning keys are secured using threaded screws that are accessible for being easily removed after the musical instrument has been assembled.

Example 21. A method for manufacturing a stringed musical instrument, comprising: optionally manufacturing an instrument body; optionally manufacturing an instrument head; optionally manufacturing a neck assembly; optionally manufacturing a coupler, the coupler having first and second positioning key portions extending therefrom in opposed directions on respective first and second sides thereof, where the shape of the first side is adapted to match at least a portion of the shape of the head and the shape of the second side is adapted to match the shape of at least a portion of the neck assembly; and securing the second side of the coupler to the neck assembly in a permanent manner and securing the second side of the coupler to the head using threaded screws that are accessible for being easily removed after the musical instrument has been assembled.

Example 22. A headstock for attachment to the neck of a stringed musical instrument, wherein the headstock includes structural formations adapted to attach to a coupler affixed to a head attachment end of the neck, the structural formations including a cavity adapted to receive a positioning key of the coupler, and the structural formations including through holes in the headstock for receiving bolts to be used to thread into the positioning key when it is received in cavity, for releasably affixing the headstock to the neck.

Example 23. The headstock of Example 22, wherein the structural formations of the headstock define at least a portion of a shape of the headstock at its connection to the neck, said shape adapted to match a shape of the coupler, so as to provide a physically smooth transition from the headstock to the neck when the headstock is affixed to the neck.

In any of the disclosed embodiments, the body and neck may also attach to one another removably or permanently. A truss rod may be included in the neck, and in some embodiments may extend from the neck to also secure the head and neck to one another.

In any of the disclosed embodiments, the neck assembly may include a reinforced spine, a grip member, a fretted fingerboard, and the coupler having a positioning key portion extending from an end of the spine. The body, neck, head, or portions thereof may be manufactured from a metal, such as aluminum or titanium, or a high-strength plastic.

Other and further embodiments are disclosed below.

### BRIEF DESCRIPTION OF THE DRAWINGS

FIG. 1 is a perspective view of a stringed musical instrument that includes that includes a body, a neck, and an interchangeable head assembly in accordance with at least some embodiments of the present disclosure.

FIG. 2 is a more detailed perspective, exploded view of the stringed musical instrument of FIG. 1.

FIG. 3A is a more detailed top perspective, exploded view of a head-neck connection of the stringed musical instrument of FIG. 1.

FIG. 3B is a top perspective view of assembled head-neck connection of the stringed musical instrument of FIG. 3A.

FIG. 3C is a top perspective view of assembled head-neck connection of a stringed musical instrument in accordance with at least some embodiments of the disclosure.

FIG. 4A is a top perspective view of an assembled prototype showing the coupler-spine connection for a stringed musical instrument of the type shown in FIGS. 3A and 3B in accordance with at least some embodiments of the present disclosure.

FIG. 4B is a bottom perspective view of an assembled prototype showing the coupler-spine connection for a stringed musical instrument of the type shown in FIGS. 3A and 3B in accordance with at least some embodiments of the present disclosure.

FIG. 5 is a bottom perspective view of an assembled prototype for a stringed musical instrument of the type shown in FIGS. 3A and 3B in accordance with at least some embodiments of the present disclosure.

FIGS. 6A and 6B are top perspective, exploded views of two alternative embodiments useful for connecting the coupler to the neck in accordance with at least some embodiments of the present disclosure.

FIG. 7A is a top perspective, exploded view of a head-neck connection of a stringed musical instrument in accordance with at least some embodiments of the disclosure.

FIG. 7B is a bottom perspective, exploded view of the head-neck connection shown in FIG. 6A.

FIG. 7C is a bottom perspective, exploded view of the head-neck connection shown in FIG. 7A.

FIG. 8A is a bottom perspective, exploded view of a head-neck connection in accordance with at least some embodiments of the present disclosure.

FIG. 8B is a bottom perspective, exploded view of a head-neck connection in accordance with at least some embodiments of the present disclosure.

FIG. 8C is a top perspective, exploded view of a head-neck connection in accordance with at least some embodiments of the present disclosure.

FIG. 9A is a bottom perspective view of a neck having a coupler in accordance with at least some embodiments of the present disclosure.

FIG. 9B is a bottom perspective view of a neck having a coupled in accordance with at least some embodiments of the present disclosure.

FIG. 10 illustrates a method for manufacturing a stringed instrument in accordance with at least some embodiments of the present disclosure.

FIG. 11 illustrates a method for manufacturing a neck for a stringed instrument in accordance with at least some embodiments of the present disclosure.

While the embodiments described herein by way of example for several embodiments and illustrative drawings, those skilled in the art will recognize that the inventive stringed instruments with interchangeable head assemblies disclosed herein are not limited to the embodiments or drawings described. The drawings and detailed description are not intended to limit embodiments to the particular form disclosed. Rather, the intention is to cover all modifications, equivalents, and alternatives falling within the spirit and scope of the methods and apparatus for providing stringed instruments with interchangeable head assemblies as defined by the appended claims. Any headings used herein are for organizational purposes only and are not meant to limit the scope of the description or the claims.

### DETAILED DESCRIPTION

Embodiments of the present invention comprise stringed instruments with interchangeable head assemblies. Various embodiments of an apparatus and method are described. In the following detailed description, numerous specific details are set forth to provide a thorough understanding of the claimed subject matter. However, it will be understood by those skilled in the art that the claimed subject matter may be practiced without including all of these specific details. In other instances, methods, apparatus, or systems that would be known by one of ordinary skill have not been described in detail so as not to obscure the claimed subject matter.

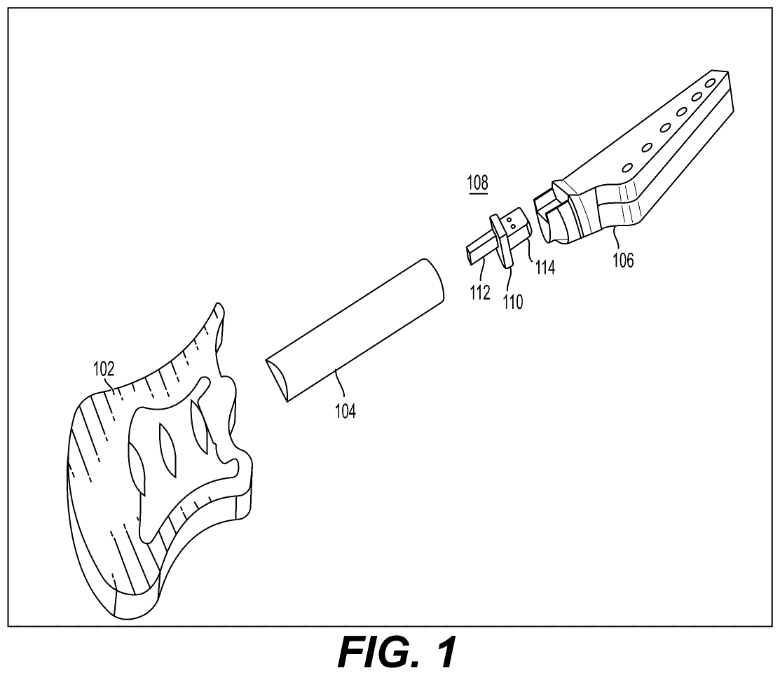

FIG. 1 is a perspective view of an exemplary stringed musical instrument (instrument) 100. Instrument 100 includes a body 102, a neck 104, and a head 106. As used herein, the terms “head” (e.g., head 106, head 225, head 300, head 700, head 801, etc.) and “headstock” are used interchangeably. Instrument 100 further includes strings that extend between body 102 and head 106, examples of which are provided further below. The strings typically extend between a bridge, disposed on the body 102, and a nut (described in more detail below) disposed near an end of the neck 104 opposite the body 102.

In the example of FIG. 1, instrument 100 is illustrated as a guitar. Features disclosed herein are not, however, limited to guitars. Features disclosed herein may be applied to a variety of other types of stringed musical instruments including, for example and without limitation, a viola, a cello, a double bass, a banjo, a mandolin, a ukulele, and/or other instrument(s).

In the illustrated embodiment a head 106 and neck 104 are removably attachable to one another by use of a coupler 108. The coupler 108 comprises a curved bulkhead or crown portion 110 having on opposed sides thereof first and second positioning keys 112 and 114. In some embodiments, the first positioning key 112 is used to permanently affix the coupler 108 to the neck while the second positioning key 114 is used to releasably affix the coupler 108 to the head 106. In some embodiments the second positioning key 114 is used to form a lap joint, that is, a joint where the portions of the head 106 and neck 104 to be connected together are overlapped and then secured one to the other by threaded means such as, for example, threaded bolts or other alternatives as described herein. Each portion to be overlapped area is thinned by approximately 25-50 percent before being overlapped, so that when overlapped upon connection, 100 percent of the thickness of the head 106 and neck 104 at their connection is restored. As noted later in this description, other joint types (e.g., mortise and tenon, a dovetail joint, key and groove and/or box joint) can be used.

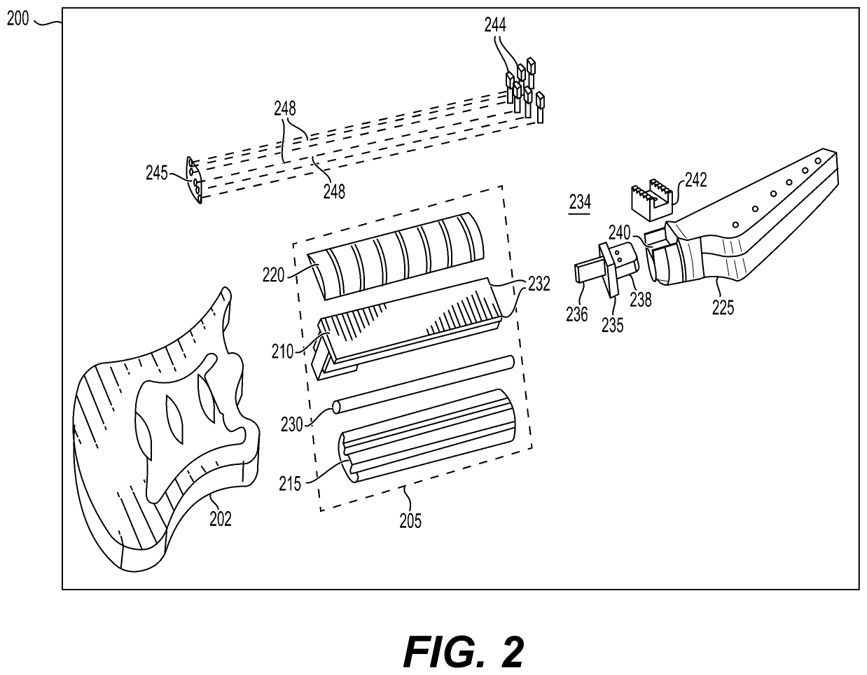

FIG. 2 is a perspective view of an exemplary stringed musical instrument (instrument) 200. Instrument 200 includes a body 202, a neck assembly 205 configured to extend from body 202, and a head 225 configured to extend from neck assembly 205. Instrument 200 further includes tuning keys 244 (e.g., disposed in head 225) and a bridge 245 (e.g., coupled to body 202) to hold strings 248.

In the example of FIG. 2, neck assembly 205 includes a grip member 215 having a curved cross-section to form a pleasing feeling for the underside of the neck, a fingerboard 220 forming its topside and a stiffening spine 210 sandwiched therebetween, typically via an adhesive such as epoxy. In some embodiments a truss rod 230 is also included within spine 210. In a preferred embodiment, spine 210 is formed of metal, such as extruded aluminum, titanium or steel and may be of the type having a flat elongate upper surface (topside) and a double-flanged bottom surface, such as shown in successive figures herein. The cross-sectional shape of spine 210 is not, however, limited to the double flanged example shown herein and many other stiffening designs are well known for elongate members.

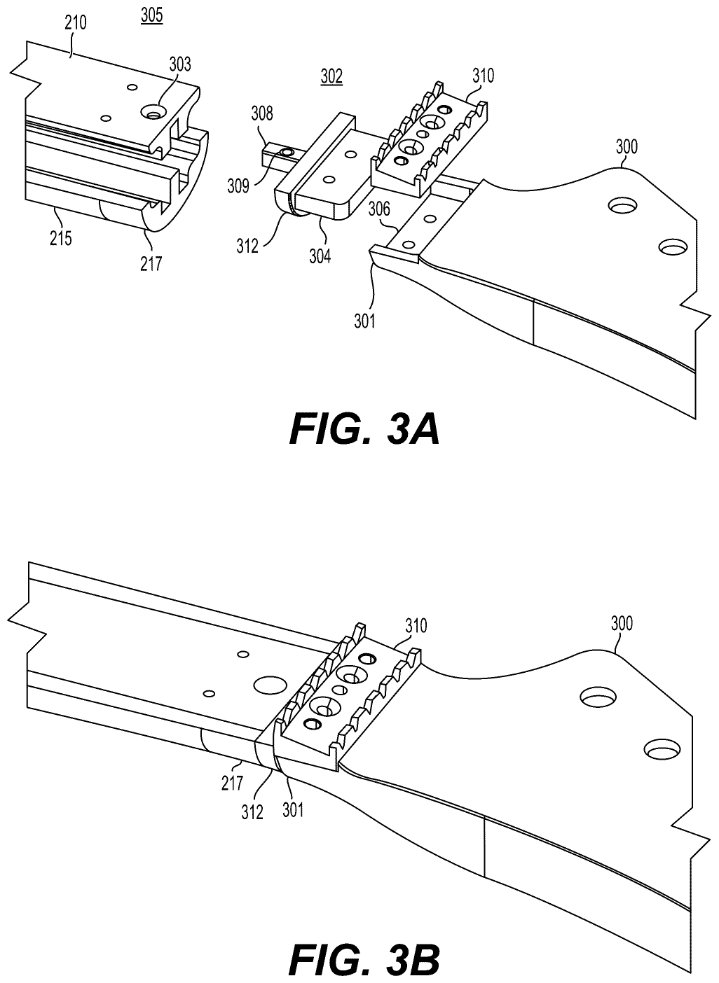

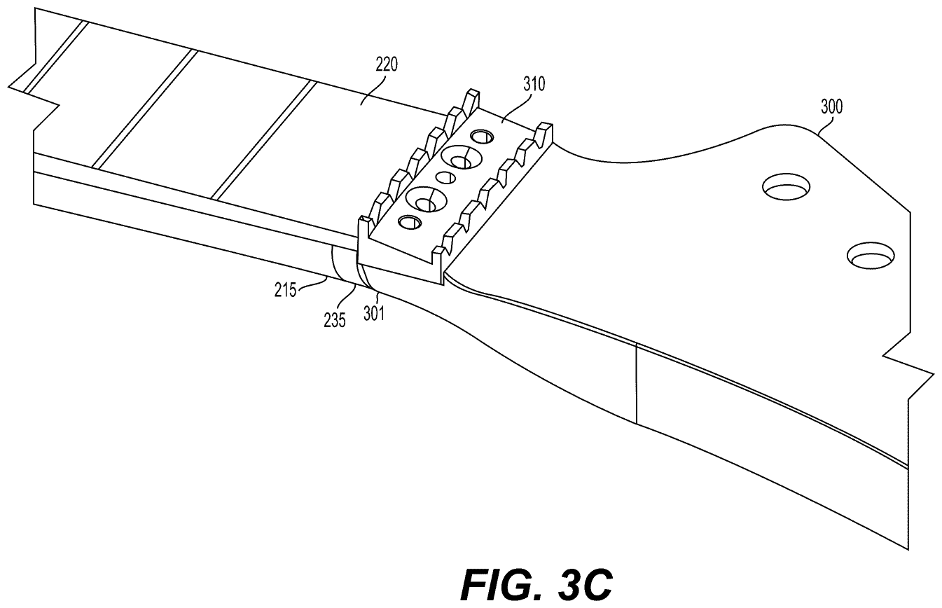

Similar to what was shown in FIG. 1, in the example of FIG. 2, head 225 and neck assembly 205 are configured to releasably attach to one another, using in the exemplary lap joint connection such as described in detail in FIGS. 3A-3B. Specifically, spine 210 includes a coupler 234 permanently affixed at its upper end. A positioning key 236 is used to precisely position the bulkhead portion at the top end of the neck assembly 205 such that the shape of the grip 215 is precisely matched to the shape of the bulkhead portion 235, while the opposite side of the bulkhead portion 235 has a positioning key 238 is used to precisely position the opposite side of the bulkhead portion 235 in relation to the head 225, so that this opposite side of bulkhead portion 235 precisely matches the shape of the head 225. The half-lap positioning key 238 is dimensioned to snugly fit in an overlapped manner within a half-lap cavity 240 of head 225.

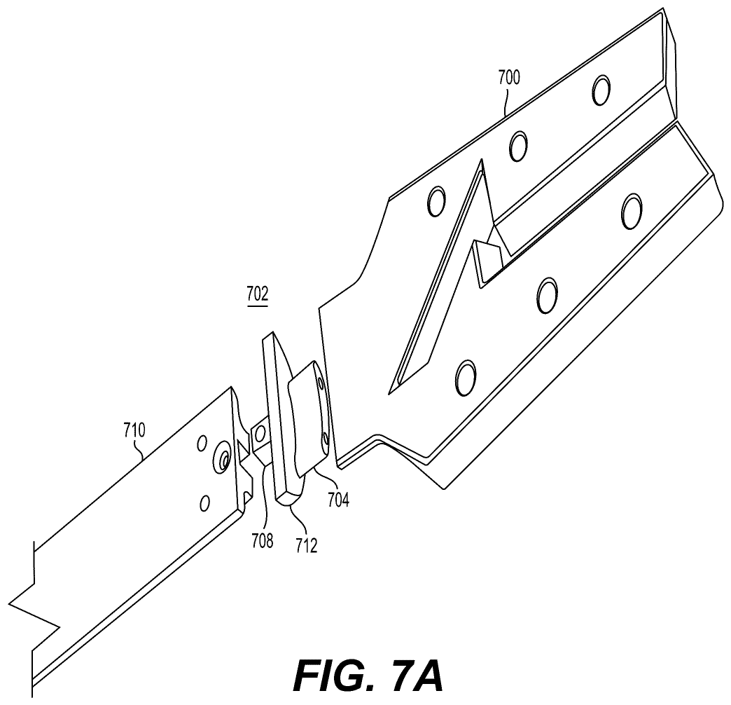

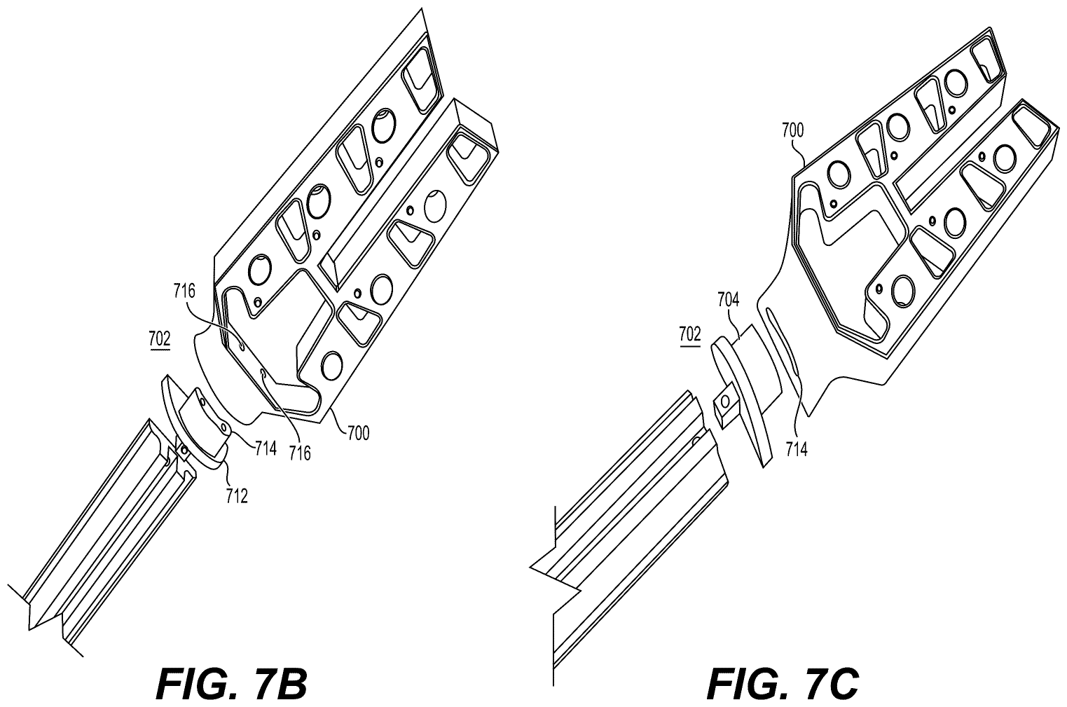

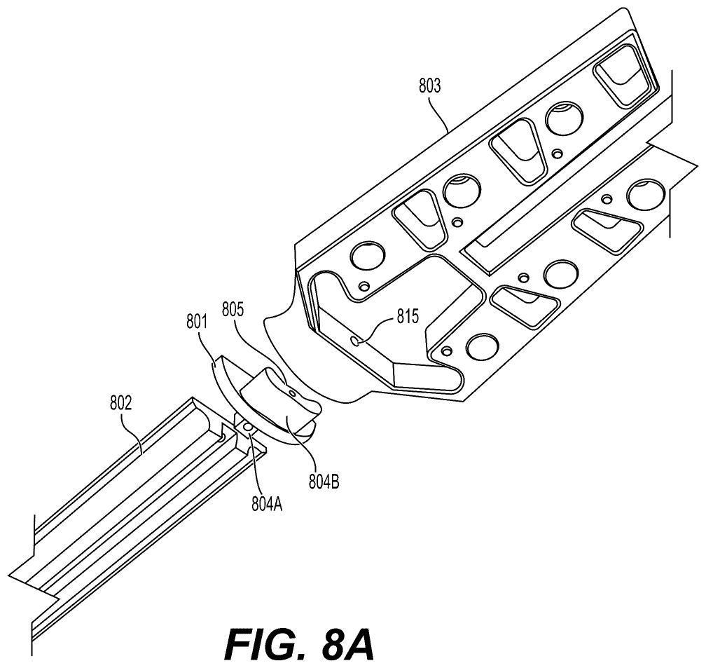

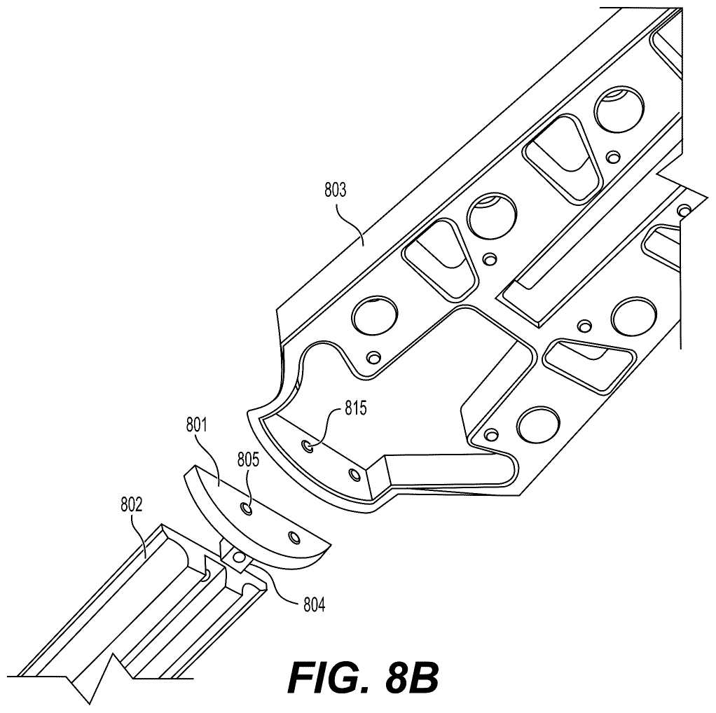

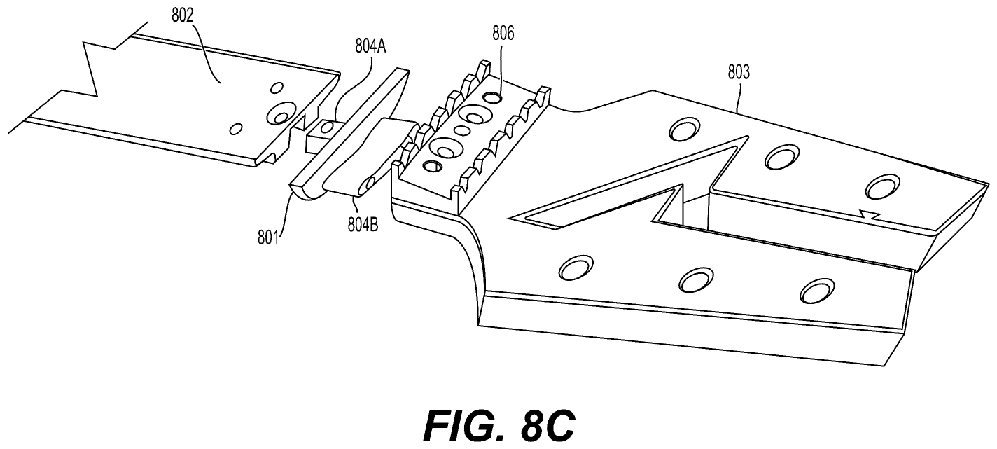

In some embodiments, and as described in greater detail in FIGS. 3A-3B, a nut 242, of well-known design, may be releasably attached on top of positioning key 238 (using threaded bolts), to provide a standard finish for the top surface of the half-lap cavity 240 which provides support for the strings 235 as they pass overhead to the tuning keys 244. Alternatively, the nut 242 can be disposed in a different manner on or above the coupler 234, on an end of the neck assembly 205, or on the head 225. Further exemplary alternative releasable connections for head 225 and neck assembly 205 are shown in FIGS. 7A-7F and 8A-8B.

Body 202, neck assembly 205, head 225, or portions thereof, may be constructed from a metal such as aluminum. For example, in some embodiments, the spine 210, or the spine 210 and at least a portion of head 225, may be constructed of aluminum or some other metal while other components, such as the body 102 and grip 215, are constructed from wood. Such an embodiment may be substantially stronger than an all-wooden construction and may be less likely to warp or break. Such an embodiment may also provide a unique sound that may not be attainable in an all-wood embodiment. Alternatively, or additionally, head 225, spine 210, or portions thereof may be fabricated from other substantially rigid material(s), such as, without limitation, a plastic, a composite material, magnesium, titanium, and/or other material(s).

Body 202, grip member 215, fingerboard 220, or portions thereof may be made from a hardwood (e.g., such as maple, oak, teak, or rosewood), a plastic, a composite material, and/or other material(s), including metals. In some embodiments, the grip member 215, fingerboard 220, or portions thereof, may be made from a non-metallic material. Implementing grip member 215, fingerboard 220, or portions thereof with a material other than metal may provide a warmer feel to a hand of a musician as compared to metal.

Embodiments that utilize certain lighter weight metals, such as aluminum, may be implemented without substantially impacting a weight of a stringed musical instrument. However, apparatus and methods disclosed herein are not limited to the aluminum examples provided herein.

Truss rods are well known to those who design stringed instruments and are configured to control a bend of a neck assembly. In FIG. 2, truss rod 230 may extend along a substantial length of neck assembly 205, yet be confined entirely within the neck assembly 205. Truss rod 230 may be positioned within or adjacent to spine 210. Truss rod 230 may be configured to stabilize a lengthwise forward curvature (e.g., a relief) of neck assembly 205. Truss rod 230 may be adjustable to provide tension in neck assembly 205 to counter forces from the pulling of strings 248. This may help keep neck assembly 205 straight.

Truss rod 230 may include an adjustable metal bar/rod (e.g., steel or titanium) that extends lengthwise through neck assembly 205, and a truss nut assembly (well known to guitar manufacturers) may be provided at one or both ends of truss rod 230 to adjust a tension of truss rod 230. Truss rod 230 may be adjusted using an adjustment tool at an attachment point between neck assembly 205 and body 202, and/or at an attachment point between neck assembly 205 and head 225.

In an alternative embodiment not shown, truss rod 230 may extend past the top end of the neck and be further configured to assist the releasable connection between head 225 and neck assembly 205. Truss rod 230 may include, for example, a threaded end configured to extend from neck assembly 205, and head 225 may have a threaded cavity adjacent to coupler 234 to receive the threaded end of truss rod 230.

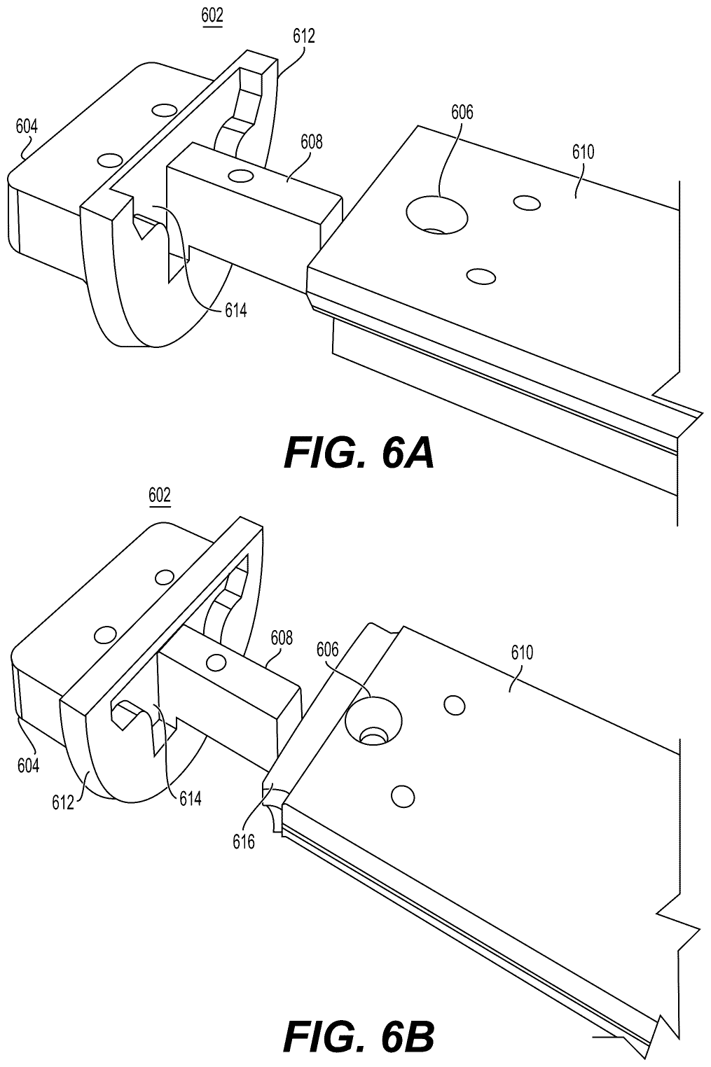

Although in FIGS. 1-3 head 225 is illustrated as a solid shaped member, this member may have its underside hollowed out in selective areas to reduce weight of head 225 relative to other designs. The shape of head 225 is not, however, limited to any particular shape, see for example the forked shape and selective hollowed areas illustrated in FIGS. 6A-6B.

FIGS. 3A-3B are, respectively, exploded and assembled perspective views of a head 300 coupled to a neck assembly 305. As noted above, head 300 may be cut, formed, or otherwise fabricated into a variety of shapes from a variety of materials. In some embodiments, the head 300 may, for example, be cut from ⅜ inch 6061 T6 grade aluminum or magnesium. Head 300 may be cut or formed as a single piece, or as multiple pieces that are thereafter joined together.

A coupler 302 of design similar to that described in FIGS. 1-2 is attached to the neck assembly 305. Coupler 302 has a bulkhead portion 312 that divides the coupler into first and second opposed sides, the first side having a shape adapted to match the shape of the end 217 of grip 215 and the second side having a shape adapted to match the shape of the underside 301 of head 300. A positioning key 308 extends from the first side of the bulkhead portion 312 so as to precisely and securely position the coupler 302 at the top end of the spine 210 and a positioning key 304 extends from the second side of the bulkhead portion 312 so as to precisely and securely position the coupler 302 in relation to the head 300. A machine screw, not shown, can pass through a counter sunk hole 303 in spine 210 and into a threaded hole 309 in positioning key 308 so as to hold coupler 302 in place at the top end of neck assembly 305. As will be described in greater detail below, a nut 310 is secured to the topside of the overlapped positioning key 304.

Head 300 has a cavity 306 formed at its receiving end that is dimensioned to be a snug fit for receiving therein positioning key 304, thereby forming a lap joint connection between head 300 and neck 305. Threaded bolts are used to releasably secure head 300 to coupler 302. In other words, head 300 and neck assembly 305 may be detachable from one another by a user. In this way, head 300 may be replaceable, and/or interchangeable with other suitably designed and manufactured pieces.

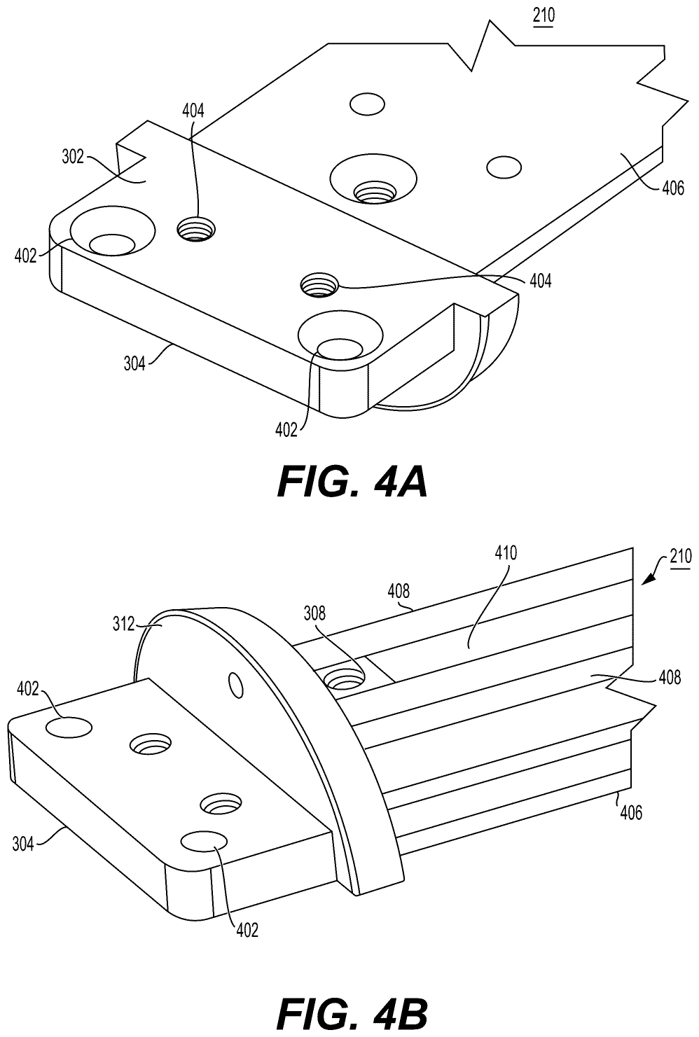

In accordance with one aspect of the invention, shown in FIGS. 4A-4B, coupler 302, threaded bolts may be used to pass through countersunk holes of positioning key 304 to releasably secure head 300 to neck 305. In other words, head 300 and neck 305 may be detachable from one another by a user. In this way, head 300 may be replaceable, and/or interchangeable with other suitably designed and manufactured heads.

The opposite end of coupler 302 has a positioning key 308 that is dimension to be a snug fit into the space between the double flanges formed on the underside of spine 210. Coupler 302 may be secured to neck assembly 305 by welding positioning key 308 to metal spine 210, using for example a known “plug-weld”, or even secured using a countersunk threaded bolt. Alternate techniques for attaching the coupler 302 to the neck assembly 305 with or without a positioning key can also be used, for example, in accordance with any of the other embodiments as disclosed herein.

A nut 310 is secured to the topside of the overlapped positioning key 304 using countersunk bolts (not shown) which thread into threaded holes shown in FIGS. 4A-4B. Nut 310 ensures that all of the strings are properly spaced and are just the right height above the fingerboard. The slots or ridges formed in the nut 310, along with clamps/caps secured to the nut, not shown, help to secure each of the guitar strings firmly in their proper place.

In some embodiments, the upper surface of the coupler is planar. In some embodiments, the upper surface of at least the bulkhead of the coupler is planar. In some embodiments, the upper surface of the coupler, or the bulkhead of the coupler, is configured to be disposed beneath a fretboard of the neck assembly. For example, in some embodiments, the upper surface of the coupler, or the bulkhead of the coupler, may be configured to be flush with an upper surface of the spine of the neck assembly. Alternatively, the upper surface of the coupler, or the bulkhead of the coupler, may be configured to be disposed above or below the upper surface of the spine of the neck assembly, while remaining at a location below an upper surface of the fretboard when installed in the neck assembly. For example, in some embodiments, when assembled, the fretboard can at completely or partially cover the bulkhead of the coupler.

For example, as depicted in FIG. 30, and as optionally applicable to other embodiments disclosed herein, in some embodiments, the bulkhead 235 of the coupler is covered by the fretboard 220 of the neck such that an end of the fretboard 220 is directly adjacent one side of the nut 310. The bulkhead 235 of the coupler is only visible from the side and back of the assembled instrument with bulkhead 235 disposed between the grip 215 of the neck and the underside 301 of the neck 300. Although illustrated with an embodiment similar to that disclosed in FIGS. 3A-3B, the configuration disclosed in FIG. 3C is not limited to the features disclosed in FIGS. 3A-3B. For example, the head and neck assembly can be different, the nut can have a different configuration or be disposed in a different location (e.g., atop the fretboard or atop the head), and the coupler configuration for connecting to the neck and/or to the head can also be as disclosed in any of the embodiments described herein.

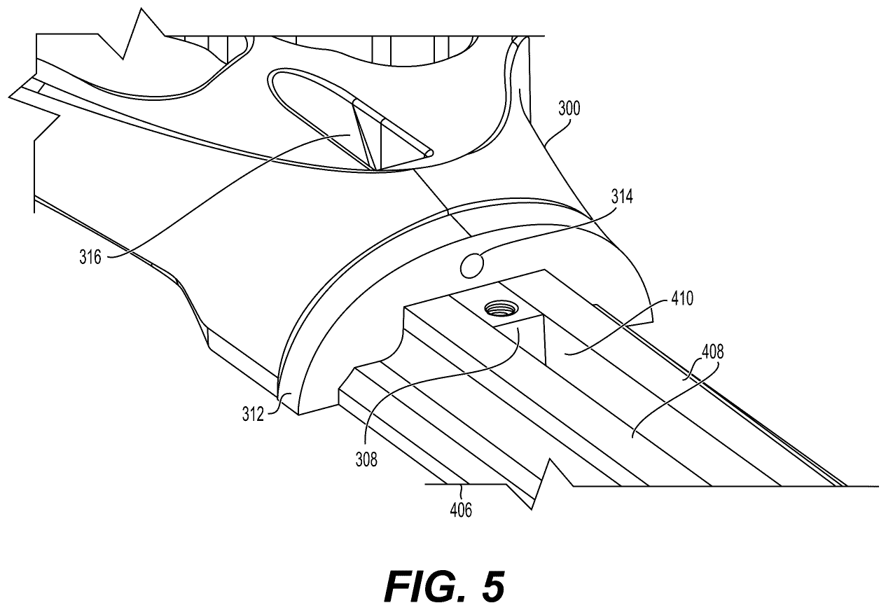

FIG. 4A is a top perspective view of an assembled neck portion showing the coupler-spine connection for a stringed musical instrument of the type shown in FIGS. 3A and 3B. FIGS. 4B and 5 illustrate the underside of the neck-head coupling.

In these examples spine 210 includes a flat, elongate top crosspiece 406 and a pair of reinforcing flanges 408 extending along a length of top crosspiece 406. Reinforcing flanges 408 define a channel or groove 410, which may extend along the length of top crosspiece 406. Coupler positioning key 308 is secured to spine 210 via, for example, plug-welding or a counter sunk screw as shown in FIG. 6A.

Counter sunk holes 402 are used to receive the threaded bolts that that pass through positioning key 304 and into threaded holes in cavity 306 to releasably secure the coupler 302 to the head 300. Threaded holes 404 are used to secure the nut 310 in a proper location with respect to the head 300.

As more clearly shown in FIG. 5, in one embodiment, when the head and neck are connected in accordance with the present invention, a threaded hole 314 in the bulkhead portion 312 of coupler 302 aligns with a corresponding through-hole 316 in the head 300. For ensuring an even more secure head-neck attachment, a shoulder bolt, not shown, is inserted into hole 316 and releasably secured into threaded hole 314. It is noted that the alignment of the bolt passing through holes 314 and 316 is substantially orthogonal to the bolts passing through holes 402, so as to provide a most durable, yet easily releasable head-neck connection. In the alternative embodiment shown in FIGS. 6A-6B, two orthogonal bolts are used to secure head 300 to bulkhead portion 312.

As previously described, bulkhead portion 312 is shaped so as to provide on one side a finished surface to abut against grip 215, and also shaped so to provide on its opposite side a finished surface to abut against head 300, thereby making assembly and manufacturing a more economical process.

Spine 210 may be formed via extrusion techniques from aluminum (e.g., aircraft aluminum), or other suitable material(s). Flanges 408 and top crosspiece 406 may be formed integrally with one another. Alternatively, flanges 408 may be welded to top crosspiece 406.

Flanges 408 may be spaced apart from one another such that spine 210 may resist torsional forces associated with warping, as well as longitudinal forces imparted to a neck assembly when strings of a corresponding instrument are tightened.

In an alternative embodiment spine 210 may include only one or even no flanges 408 and instead neck assembly 205 can rely on truss rod 230 or other device to help neck assembly 205 resist warping.

Features of spine 210 (e.g., dimensions and/or material(s)), may be selected and/or altered for strength and/or tonal quality. For example, and without limitation, top crosspiece 405 and flanges 408, or other members of a neck assembly, may be ribbed to further reinforce the neck assembly against warping, bending, and twisting.

FIGS. 6A and 6B are top perspective, exploded views of two alternative embodiments useful for connecting a coupler constructed in accordance with the invention to the neck for a stringed instrument. In FIG. 6A coupler 602 has a bulkhead portion 612 where the side facing spine 610 has a shaped cavity 614 machined therein so as to receive the top end of spine 610. In FIG. 6A, cavity 614 is shaped so that when positioning key 608 is aligned with hole 606 the top surface of spine 610 aligns with and forms the top surface of bulkhead portion 612. In FIG. 6B, the top end of spine 610 is machined so as to facilitate forming a tongue and mortise connection to the head 300. A tongue 616 is shaped to match the shape of a mortise cavity 614 formed in bulkhead portion 612. In both cases the positioning key 608 is aligned with hole 606 and a countersunk bolt, not shown, is used to secure coupler 602 to spine 610. In some embodiments an epoxy or other means may also be used to further secure the coupler-spine connection.

FIGS. 7A-7B are top and bottom perspective, exploded views, respectively, of a head-neck connection for a stringed musical instrument constructed, in accordance with another embodiment of the invention. FIG. 7C is a slightly different bottom-perspective, exploded view of the head-neck connection shown in FIG. 7B.

As shown in FIGS. 7A-7C, coupler 702 is shaped and operates substantially the same as coupler 302 shown in FIGS. 3A-3B in that there is a bulkhead portion 712 from which opposed positioning keys 704 and 708 extend. Key 708 is shaped and connected to spine 710 in a manner similar to that described with respect to any of the previous figures, however the positioning key 704 is curved, as compared with the flat positioning key 304 shown in FIGS. 3A-3B. Additionally, as shown in FIG. 7B, a curved mortise cavity 714 is formed in head 700 to receive the curved positioning key 704. Two through holes 716 are formed in the underside of head 700 through which shoulder bolts, not shown, are used to thread into correspondingly positioned threaded holes in positioning key 714, so as to releasably secured head 700 to coupler 702.

FIG. 8A is a bottom perspective, exploded view of a head-neck connection in accordance with at least some embodiments of the present disclosure. In embodiments consistent with FIG. 8A, a head 803 includes one hole 815 for a bolt to affix the head 803 to a coupler 801. The coupler 801 can include a first tongue 804A that mates with a spine 802 of the neck assembly and a second tongue 804B that mates with the head 803. A hole 805 in tongue 804B of the coupler 801 aligns with the hole 815 of the head 803. This embodiment only needs one securing fastener or bolt, since the tongue 804B of the coupler facing the head 803 is inserted into the head 903 and makes the connection stable between the head 903 and the coupler 807 bulkhead 801.

FIG. 8B is a bottom perspective, exploded view of a head-neck connection in accordance with at least some embodiments of the present disclosure. In embodiments consistent with FIG. 8B, the head 803 is fastened (e.g., bolted) to the coupler 801 without a second tongue facing the head (only tongue 804 extending toward the spine 802 is provided). In this embodiment, the coupler 807 includes one or more, and in some embodiments, at least two holes 805 for fasteners such as bolts. The head 803 includes a corresponding number of holes 815 (e.g., one or more or at least two) that align with each of the holes 805. The fasteners securing the head to the coupler in this embodiment provide the stability of connection between the head and the neck. Providing a coupler without the second tongue extending toward the neck advantageously provides a stable connection with less mass, making the coupler 801 (and thus the head 803) lighter.

FIG. 8C is a top perspective, exploded view of a head-neck connection in accordance with at least some embodiments of the present disclosure. In embodiments consistent with FIG. 8C, a nut 806 is shown affixed to the top of the head 803. This embodiment illustrates how the position of the nut 806 is independent of the coupler 801. As noted previously, the independent placement of the nut can be incorporated into any of the embodiments disclosed herein, unless explicitly disclosed to the contrary (e.g., where the coupler includes a portion adapted to receive the nut). Hence, the coupler 801 (or any of the couplers disclosed herein) can advantageously be used solely as a connection interface between the head and the neck.

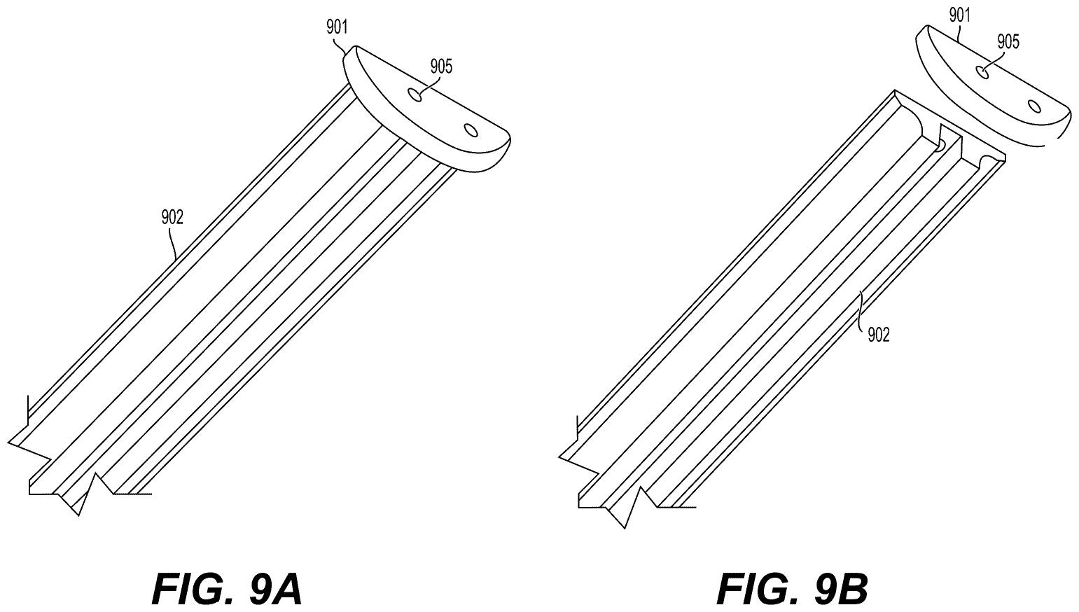

FIG. 9A is a bottom perspective view of a neck having a coupler in accordance with at least some embodiments of the present disclosure. In embodiments consistent with FIG. 9A, a coupler bulkhead 901 can be permanently attached directly to the spine 902 of the neck assembly for example, using an adhesive, welding, or casting. The coupler includes one or more holes 905 for connecting the head to the neck assembly via the coupler. The advantage of this embodiment is reduced machining of the coupler, resulting in lower cost of fabrication. Another advantage is less mass of the coupler, making the embodiment lighter. FIG. 9B is a bottom perspective view the embodiment of FIG. 9A showing the coupler bulkhead 901 separated from the spine 902 extrusion.

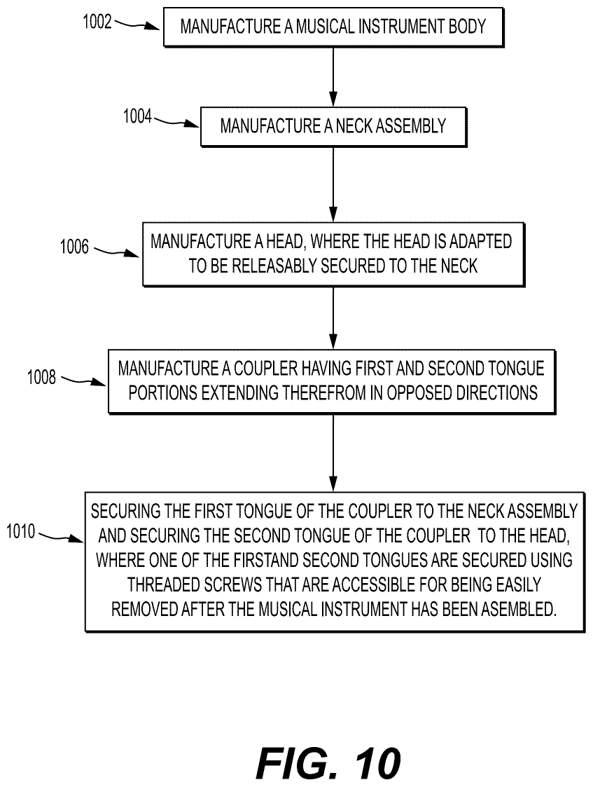

FIG. 10 is a process flowchart of a method 1000 for manufacturing a stringed musical instrument. Methods of manufacturing a stringed musical instrument are not, however, limited to the example of FIG. 10.

At 1002, optionally, an instrument body is manufactured. The instrument body may be configured in any suitable manner consistent with the disclosure provided herein. Alternatively, a premanufactured body can be obtained.

At 1004, optionally, a neck assembly is manufactured. The neck assembly may be configured in accordance with any of the examples described herein. Alternatively, a premanufactured neck assembly can be obtained.

At 1006, optionally, a head is manufactured. The head may be configured in accordance with any of the examples described herein. Alternatively, a premanufactured head can be obtained.

At 1008, optionally, a coupler is manufactured, the coupler having first and second positioning key portions extending therefrom in opposed directions. Alternatively, a pre-manufactured coupler having the aforementioned features and in accordance with any of the embodiments disclosed herein can be obtained.

At 1010, the body, the neck assembly, and the head are connected to one another. The neck assembly and the head are connected to one another by securing the first positioning key of the coupler to the neck assembly and securing the second positioning key of the coupler to the head, where one of the first and second positioning keys are secured using threaded screws that are accessible for being easily removed after the musical instrument has been assembled.

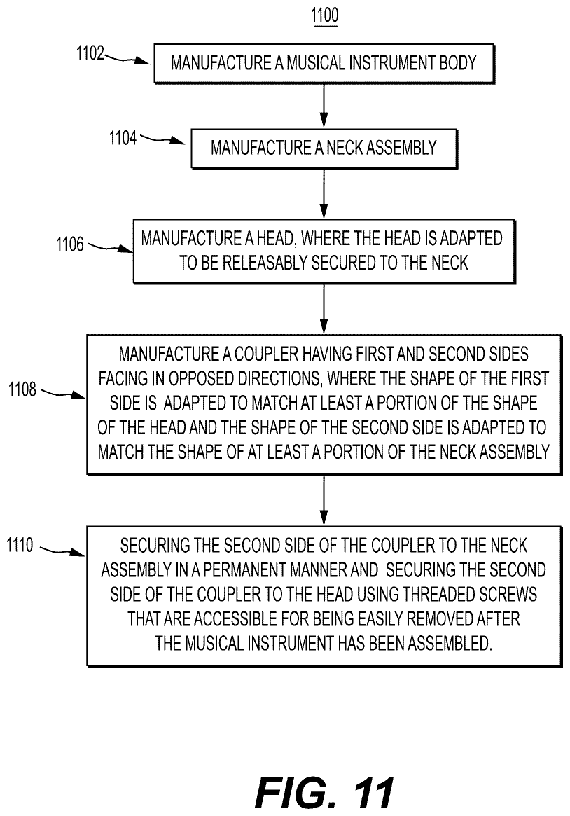

FIG. 11 is a process flowchart of a method 1100 for manufacturing a stringed musical instrument. Methods of manufacturing a stringed musical instrument are not, however, limited to the example of FIG. 11.

At 1102, optionally, an instrument body is manufactured. The instrument body may be configured in any suitable manner consistent with the disclosure provided herein. Alternatively, a premanufactured body can be obtained.

At 1104, optionally, a neck assembly is manufactured. The neck assembly may be configured in accordance with any of the examples described herein. Alternatively, a premanufactured neck can be obtained.

At 1106, optionally, a head is manufactured. The head may be configured in accordance with any of the examples described herein. Alternatively, a premanufactured head can be obtained.

At 1108, optionally, a coupler is manufactured, the coupler having first and second positioning key portions extending therefrom in opposed directions, where the shape of the first side is adapted to match at least a portion of the shape of the head and the shape of the second side is adapted to match the shape of at least a portion of the neck assembly. Alternatively, a pre-manufactured coupler having the aforementioned features and in accordance with any of the embodiments disclosed herein can be obtained.

At 1110, the body, the neck assembly, and the head are connected to one another. The neck assembly and the head are connected to one another by securing the first positioning key of the coupler to the neck assembly and securing the second positioning key of the coupler to the head, where one of the first and second positioning keys are secured using threaded screws that are accessible for being easily removed after the musical instrument has been assembled. The body can be coupled to the neck assembly prior to or subsequent to connecting the neck assembly to the head via the coupler.

One or more features of methods 1000 or 1100 may be performed by a programmable machine and/or special purpose hardware. For example, methods 1000 or 1100 may include milling metal (e.g., aluminum), such as to provide the joints and/or to provide a truss rod cavity. Alternatively or in combination, methods 1000 or 1100 may include welding or use of an adhesive such as epoxy in an area of attachment between the body and neck and/or between the neck and the coupler constructed in accordance with the present disclosure.

Methods 1000 or 1100 can be used in connection with manufacturing an entire stringed instrument, or a portion thereof, such as either or both of a neck portion of a stringed instrument and/or a corresponding shaped head portion specifically designed to be attached to a neck assembly constructed in accordance with the present disclosure.

Techniques to attach components of a stringed musical instrument may provide stronger head and neck attachments, which may reduce occurrence of attachment failure (e.g., breaking or snapping of the head or neck may be reduced). Further, interchangeability of instrument heads may provide users (e.g., musicians, musical instrument manufacturers, etc.) increased flexibility in customizing different musical instruments, as different heads can be designed in any shape and to match any instrument.

Various combinations and/or sub-combinations of the specific features and aspects of the above embodiments may be made and still fall within the scope of the disclosure. Accordingly, it should be understood that various features and aspects of the disclosed embodiments may be combined with or substituted for one another in order to form varying modes of the disclosed invention. Further, the scope of the present disclosure is provided herein by way of examples and should not be limited by the particular embodiments described above. While the foregoing is directed to embodiments of the present invention, other and further embodiments of the invention may be devised without departing from the basic scope thereof.

We claim:

1. A stringed musical instrument, comprising:
a body;
a neck extending from the body;
a head extending from the neck; and
a coupler disposed between and coupled to each of the neck and the head, the coupler having a bulkhead portion that divides the coupler into first and second opposed sides, the first side having a shape adapted to match at least a portion of the shape of the neck and the second side having a shape adapted to match at least a portion of the shape of the head.

2. The stringed musical instrument of claim 1, wherein the first side of the coupler is adapted to abut and be permanently affixed to the neck and the second side of the coupler is adapted to abut and be releasably attached the head.

3. The stringed instrument of claim 1, wherein the coupler further comprises first and second positioning keys extending on opposing sides of the bulkhead portion to releasably attach the head to the neck.

4. The stringed instrument of claim 3, wherein the first positioning key is affixed to the neck so that the bulkhead portion of the coupler facing the neck provides a first finishing surface to the neck and the second positioning key is affixed to the head so that the bulkhead portion of the coupler facing the head provides a second finishing surface to the head.

5. The stringed instrument of claim 4, wherein at least one of:
the first positioning key is releasably affixed to the neck; or
the second positioning key is releasably affixed to the head.

6. The stringed instrument of claim 4, wherein the first positioning key is permanently affixed to the neck and the second positioning key is adapted to releasably fit into a cavity formed in a portion of the head so as to permit a releasable connection of the head to the neck when the second positioning key is positioned in the cavity of the head.

7. The stringed instrument of claim 6, further comprising a first threaded means adapted to pass through a hole formed along a longitudinal axis of the head and thread into a hole in the second positioning key.

8. The stringed instrument of claim 6, wherein the second positioning key has a width of at least 50% or more of the average width of the head at its connection with the coupler and a thickness of about 25% or more of the average thickness of the head at its connection with the coupler.

9. The stringed instrument of claim 6, further comprising a first threaded means adapted to pass in a first direction through the second positioning key and a mortise portion of the head and a second threaded means adapted to pass in a second direction, substantially perpendicular to the first direction, through the head and into the bulkhead portion of the coupler facing the head.

10. The stringed instrument of claim 9, wherein the second positioning key has at least one hole formed therein that aligns with at least one threaded hole in the head mortise, for releasably securing the head to the neck with the first threaded means, and the head has a hole formed therein that aligns a threaded hole in the bulkhead portion for releasably securing the head to the neck with the second threaded means.

11. The stringed instrument of claim 6, wherein the first positioning key is permanently affixed to a metallic support in the neck.

12. The stringed instrument of claim 1, wherein a neck side of the bulkhead portion provides finish to a grip portion of the neck and a nut mounted on the second positioning key provides a finishing surface for a fingerboard portion of the neck.

13. The stringed musical instrument of claim 1, wherein the coupler further comprises a first positioning key extending from a first side thereof for connecting the coupler to the neck, and a second positioning key extending from an opposite second side thereof;
wherein the head includes a cavity adapted to receive the second positioning key; and
wherein the head and the neck are configured to releasably attach to one another using the second positioning key and cavity to form a lap or mortise joint.

14. The stringed musical instrument of claim 13, wherein the second positioning key has a width of at least 50% or more of the average width of the head at its connection with the neck and a thickness of at least 25% or more of the average thickness of the head at its connection with the neck.

15. The stringed musical instrument of claim 14, further including releasable attaching means, comprising:
a first threaded means adapted to pass in a first direction through the positioning key and cavity of the lap or mortise joint and a second threaded means adapted to pass in a second direction, substantially perpendicular to the first direction, through the head and into the coupler.

16. The stringed musical instrument of claim 13, further including releasable attaching means, comprising:
a first threaded means adapted to pass in a first direction through the positioning key and cavity of the lap or mortise joint and a second threaded means adapted to pass in a second direction, substantially perpendicular to the first direction, through the head and into the coupler.

17. A neck assembly for a stringed musical instrument, wherein the neck includes a coupler having a bulkhead portion that divides the coupler into first and second opposed sides, the first side being permanently attached to the neck and having a shape that matches at least a portion of the shape of the neck and wherein the second side of the coupler has a shape adapted to match at least a portion of the shape of a head to be releasably secured to the neck.

18. The neck assembly for a stringed instrument of claim 17, wherein the neck includes a stiffener sandwiched between a fretboard on a topside of the neck and a grip on a bottom side of the neck, and wherein the bulkhead portion of the coupler is shaped to abut against and match a shape of the grip portion of the neck.

19. A headstock for attachment to a neck of a stringed musical instrument, wherein the headstock includes structural formations adapted to attach to a coupler affixed to a head attachment end of the neck, the structural formations including a cavity adapted to receive a positioning key of the coupler, and the structural formations including through holes in the headstock for receiving bolts to be used to thread into the positioning key when it is received in cavity, for releasably affixing the headstock to the neck.

20. The headstock of claim 19, wherein the structural formations of the headstock define at least a portion of a shape of the headstock at its connection to the neck, said shape adapted to match a shape of the coupler, so as to provide a physically smooth transition from the headstock to the neck when the headstock is affixed to the neck.

21. A method for manufacturing a stringed musical instrument, comprising:
fastening a headstock to a neck via a coupler, the coupler having first and second positioning keys extending therefrom in opposed directions, wherein the first positioning key is fastened to the neck and the second positioning key is fastened to the head, wherein at least one of the first and second positioning keys are fastened using threaded screws that are accessible for being removed after the musical instrument has been assembled.

22. The method of claim 21, further comprising:
manufacturing an instrument body;
manufacturing the head;
manufacturing the neck; and
manufacturing the coupler; and
connecting the instrument body to the neck.

23. The method of claim 22, wherein the shape of a first side of the coupler is adapted to match at least a portion of the shape of the neck at an interface of the coupler and the neck and the shape of a second side of the coupler is adapted to match the shape of at least a portion of the head at an interface between the coupler and the head, and further comprising securing the first side of the coupler to the neck in a permanent manner and securing the second side of the coupler to the head using threaded screws that are accessible for being easily removed after the musical instrument has been assembled.
